(19) United States
(12) Patent Application Publication
(10) Pub. No.: US 2025/0207277 A1
(43) Pub. Date: Jun. 26, 2025

(54) CATALYTIC MATERIAL BASED ON A GROUP VIB ELEMENT AND A GROUP IVB ELEMENT FOR THE PRODUCTION OF HYDROGEN BY ELECTROLYSIS OF WATER

(71) Applicants: IFP ENERGIES NOUVELLES, RUEIL-MALMAISON (FR); ECOLE NORMALE SUPERIEURE DE LYON, Lyon (FR); CENTRE NATIONAL DE LA RECHERCHE SCIENTIFIQUE (CNRS), Paris (FR); UNIVERSITE CLAUDE BERNARD (LYON 1), VILLEURBANNE (FR); GRENOBLE INP (INSTITUT POLYTECHNIQUE DE GRENOBLE), Grenoble (FR); UNIVERSITE SAVOIE MONT BLANC, Chambery (FR); UNIVERSITE GRENOBLE ALPES, Saint-Martin D'heres (FR)

(72) Inventors: Audrey BONDUELLE, Rueil-Malmaison Cedex (FR); Mona Marie OBADIA, Rueil-Malmaison Cedex (FR); Quentin CACCIUTTOLO, Rueil-Malmaison Cedex (FR); Stephan STEINMANN, Villeurbanne (FR); Nawras ABIDI, Venissieux (FR); Laetitia DUBAU, Grenoble (FR); Eric SIBERT, Saint-Martin D'heres (FR)

(73) Assignees: IFP ENERGIES NOUVELLES, Rueil-Malmaison Cedex (FR); ECOLE NORMALE SUPERIEURE DE LYON, Lyon (FR); CENTRE NATIONAL DE LA RECHERCHE SCIENTIFIQUE (CNRS), Paris (FR); UNIVERSITE CLAUDE BERNARD (LYON 1), Villeurbanne (FR); GRENOBLE INP (INSTITUT POLYTECHNIQUE DE GRENOBLE), Grenoble (FR); UNIVERSITE SAVOIE MONT BLANC, Chambery (FR); UNIVERSITE GRENOBLE ALPES, Saint-Martin D'heres (FR)

(21) Appl. No.: 18/847,907

(22) PCT Filed: Mar. 8, 2023
(86) PCT No.: PCT/EP2023/055823

§ 371 Date: Sep. 17, 2024

(30) Foreign Application Priority Data
Mar. 18, 2022 (FR) FR2202406

(51) Int. Cl. C25B 11/091; C25B 1/04; C25B 1/27; C25B 3/07; C25B 11/063; C25B 11/065; C25B 11/067; H01M 4/90

(52) U.S. Cl. CPC C25B 11/091; C25B 1/04; C25B 1/27; C25B 3/07; C25B 11/063; C25B 11/065; C25B 11/067; H01M 4/9083

(57) ABSTRACT

A catalytic material comprising at least one group VIB metal at least partly in sulfide form, at least one group IVB metal at least partly in sulfide form, and an electrically conductive support wherein said group VIB metal is chosen from molybdenum and/or tungsten, said group IVB metal is chosen from titanium, zirconium and/or hafnium.

### TECHNICAL FIELD

The present invention relates to the field of electrodes capable of being used for electrochemical reduction reactions, in particular for the electrolysis of water in a liquid electrolytic medium in order to produce hydrogen.

### PRIOR ART

Today, molecular hydrogen is an essential energy vector in the energy transition. It is necessary to produce molecular hydrogen with a low emission of greenhouse gas for current industrial applications (refinery, production of aqueous ammonia, hydrogenation or reduction process). For example, it can be used for mobility (car, heavy transportation, railroad, aviation) applications, to replace methane in combustion furnaces (the combustion of H₂ in fact produces only water) or to store intermittent solar or wind energy. One of the technologies for producing decarbonized hydrogen is electrolysis of water. In a water electrolysis cell, the hydrogen evolution reaction (HER) occurs at the cathode and the oxydation evolution reaction (OER) occurs at the anode. The overall reaction is:

H₂O→H₂+½O₂

The potential of the electrochemical proton reduction reaction is 0 V/NHE, NHE being the normal hydrogen electrode, a reference electrode. This potential represents the thermodynamic energy needed for the reduction. However, it is necessary to add to this minimum thermodynamic energy overpotentials linked to the activation of the reaction by the material at the interface between the electrons and protons and where the gas can form. These days, the material most widely used for this electrocatalyst work, and in the case of proton exchange membrane (PEM) electrolyzers, is platinum. Although the electrocatalytic properties are excellent, platinum is however expensive and scarce. A major research effort is now being made to replace platinum with a material that is more abundant and cheaper but has identical or even better catalytic properties.

Catalysts based on metals from column VIB of the periodic table, which includes MoS₂, are catalysts of interest for electroreduction reactions, in particular for the production of H₂. Patent applications US2022/0018033 and US2022/010439 disclose various methods for preparing catalysts with at least one active phase precursor based on a group VIB metal and optionally at least one active phase precursor of a group VIII metal.

The materials based on MoS₂ have a lamellar structure exhibiting electrocatalytic properties in HER. The active phases can be used in bulk form when the conduction of the electrons from the cathode is sufficient or else in the supported state, then bringing into play a support of a different nature. In the latter case, the support must have specific properties:
high specific surface area in order to promote the dispersion of the active phase;
very good electronic conductivity;
chemical and electrochemical stability under water electrolysis conditions.

Carbon is the most commonly used support for PEM electrolyzers.

However, MoS₂ alone remains less effective than platinum for the reaction of interest. For example Y. Zhao et al. Sc. Reports, 5, 8722 reports an overpotential with platinum of 50 mV and an overpotential of 220 mV for MoS₂ in the form of nanosheets on graphene sheets. Several strategies can be developed to lower the overpotentials of an MoS₂-based catalyst. For example, it is accepted that a catalyst exhibiting a high catalytic potential is characterized by an associated active phase perfectly dispersed at the surface of the support and exhibiting a high active phase content. However, once the catalyst is perfectly dispersed, its electrocatalytic properties are limited by its intrinsic properties.

To improve its intrinsic properties, MoS₂ can be promoted by numerous dopants. Document CN111847513 discloses dopants such as vanadium, chromium, manganese, rhenium, iridium, platinum or gold or a metalloid such as fluorine, oxygen, selenium, tellurium, nitrogen, phosphorus, carbon or boron. Similarly, document CN110479311 includes MoS₂/graphene composite materials in which the MoS₂ is doped with at least one of the following elements: vanadium, chromium, manganese, iron, cobalt, nickel, copper, zinc, ruthenium, rhodium, palladium, silver, cadmium, platinum or gold. Other prior art documents are more specific to the addition of just one or two heteroatoms doping molybdenum sulfide or forming a composite therewith:
cobalt: CN107881529 discloses a catalyst comprising a cobalt disulfide phase, CN110026210 discloses a C—N/Co₄Sa/MoS₂ catalyst, CN109046409 relates to a catalyst with cobalt phosphide-molybdenum sulfide nanosheets on carbon nanotubes, CN113668008 describes a Co—MoS₂ catalyst on carbon nanotubes, CN113061928 discloses a catalyst based on molybdenum sulfide nanosheets and cobalt sulfide nanoparticles, CN107904620 describes a catalyst on a 3D support (with graphene and carbon nanotubes) and a molybdenum sulfide/cobalt sulfide composite, and CN109796044 discloses a catalyst based on cobalt-molybdenum sulfide supported on palladium,
nickel: CN108517534 discloses nickel-doped molybdenum sulfide, CN108441879 describes a composite of molybdenum sulfide, nanoporous nickel and graphene, CN105655140 presents a molybdenum sulfide-nickel sulfide-graphene composite in flake form, CN111992227 discloses a nickel cobalt-molybdenum sulfide composite and CN110327946 discloses a molybdenum sulfide-nickel selenide composite,
vanadium: CN109939699 presents a flower-like vanadium-doped molybdenum sulfide catalyst, CN107574454 describes a tungsten-doped vanadium dioxide nanotube/molybdenum sulfide composite,
iron: US2021/170384 describes molybdenum sulfide nanosheets with dispersed iron phosphide nanoparticles,
gold: CN108654647 discloses molybdenum sulfide with gold nanoparticles,
cadmium: CN111229260 discloses a catalyst based on molybdenum sulfide and cadmium sulfide,
nitrogen, which can be used to dope the carbon support as described above, but which can also form nitrides with molybdenum sulfide. For example, CN109161919 and CN113846347 disclose a catalyst formed of carbon nitride-molybdenum sulfide binary compound and carbon/molybdenum sulfide-molybdenum nitride, respectively.

Molybdenum sulfide-based catalysts which contain elements from group IVB of the periodic table have been little studied. Only catalysts with molybdenum sulfide and with the presence of titanium are described in the literature. Usually, the titanium is found in the substrate as described by M. Medina et al. J. Braz. Chem. Soc. 30 2210, E. Girel et al. Catalyst Today 292, 154, A. Jagminas et al. Metals 10, 1251 and A. Tahira et al. ACS Appl. Energy Mater. 3, 2053 and which are the subject of patent applications CN109097790 in which titanium wires are used as a support for carbon fibers, CN102849798 in which the substrate may be carbon, molybdenum, tungsten, silver, copper or titanium and CN113755827 with molybdenum sulfide crystal based on a titanium mesh. It can also form composite materials with molybdenum sulfide. K. M. Alagad et al. 47, 2366, Y. Kim et al. Advanced Functional Materials, 27 1701825 and J. Liang et al. ACS Appl. Mater. Interfaces 10, 6084 study the catalytic properties of a TiO₂/MoS₂ composite with various microstructures. A composite of the same family is also the subject of patent application CN110252345. Here the composite is formed of graphene, molybdenum sulfide and titanium dioxide with an accordion structure. Finally, J. Liu et al. Applied Catalyst B: Environmental 241, 89 describe MoS₂/Ti₃C₂Tₓ hybrids with very good electrocatalytic activities.

Finally, no catalyst with MoS₂ or another metal from column VIB of the periodic table doped with titanium or another element from group IVB is described in the literature.

The applicant company has developed a new process for the preparation of a catalytic material making it possible to obtain an electrode which can be used in an electrolytic cell for carrying out an electrochemical reduction reaction, and more particularly which makes it possible to obtain a cathode which can be used in an electrolytic cell for the production of hydrogen by electrolysis of water. Specifically, the applicant has surprisingly discovered that the deposition of at least one group VIB metal in the presence of at least one group IVB metal on an electrically conductive support makes it possible to obtain a catalytic material having a catalytic performance which is at least as good as, or better than, that obtained using catalytic materials according to the prior art, in particular when the latter is used as catalytic phase of an electrode for electrochemical reduction reactions, even more particularly when the catalytic material is used as catalytic phase of a cathode for the production of hydrogen by electrolysis of water.

### Subjects of the Invention

A first subject according to the invention relates to a catalytic material comprising an active phase comprising at least one group VIB metal at least partly in sulfide form, at least one group IVB metal at least partly in sulfide form, and an electrically conductive support wherein said group VIB metal is chosen from molybdenum and/or tungsten, said group IVB metal is chosen from titanium, zirconium and/or hafnium.

According to one or more embodiments, when the group VIB metal is molybdenum, the molybdenum content is between 4% and 60% by weight of molybdenum element relative to the weight of the catalytic material.

According to one or more embodiments, when the group VIB metal is tungsten, the tungsten content is between 7% and 70% by weight of tungsten element relative to the weight of the catalytic material.

According to one or more embodiments, the content of group IVB metal is advantageously between 0.1% and 25% by weight of group IVB element relative to the total weight of the catalytic material.

According to one or more embodiments, the active phase is chosen from the group formed by the combinations of the elements titanium-molybdenum, zirconium-molybdenum, hafnium-molybdenum, titanium-zirconium-molybdenum, titanium-hafnium-molybdenum, zirconium-hafnium-molybdenum, titanium-tungsten, zirconium-tungsten, hafnium-tungsten, titanium-zirconium-tungsten, titanium-hafnium-tungsten, zirconium-hafnium-tungsten, titanium-molybdenum-tungsten, zirconium-molybdenum-tungsten and hafnium-molybdenum-tungsten.

According to one or more embodiments, said catalytic material further comprises at least one doping material chosen from boron, phosphorus and silicon.

According to one or more embodiments, the electrically conductive support is chosen from:
carbon black, graphite, carbon nanotubes and graphene;
nickel, gold, copper, silver, titanium and silicon;
fluorine-doped tin dioxide and indium tin oxide.

According to one or more embodiments, the support of the catalytic material has a specific surface area of greater than 75 m²/g.

Another subject according to the invention relates to a process for preparing a catalytic material according to the invention, said process comprises at least the following steps:
a) a step of bringing said support into contact with at least one solution containing at least one precursor of at least one group VIB metal;
b) a step of bringing said support into contact with at least one solution containing at least one precursor of at least one group IVB metal;
steps a) and b) being carried out in any order or simultaneously;
c) a drying step on conclusion of the sequence of steps a) and b) or b) and a), at a temperature below 250° C., without a subsequent calcination step;
d) a step of sulfurization of the material obtained on conclusion of step c) at a temperature of between 100° C. and 600° C.

According to one or more embodiments, said precursor of at least one group VIB metal is chosen from:
polyoxometalates corresponding to the formula (HₕXₓMₘO_{y})^{q-} wherein H is hydrogen, X is an element chosen from phosphorus (P), silicon (Si) and boron (B), said element being taken alone, M is one or more elements chosen from molybdenum (Mo) and tungsten (W), O being oxygen, h being an integer between 0 and 12, x being an integer between 0 and 4, m being an integer equal to 5, 6, 7, 8, 9, 10, 11, 12 or 18, y being an integer between 17 and 72 and q being an integer between 1 and 20;
salts of precursors of the group VIB elements; and
organic or inorganic precursors based on Mo or W.

According to one or more embodiments, said precursor of at least one group IVB metal is chosen from alkoxides of zirconium, hafnium and titanium, zirconium hydroxide, hafnium hydroxide, hafnium oxalate, hafnium nitrate and hafnium sulfate.

According to one or more embodiments, a maturation step is carried out after step a) and/or b), and before step c), at a temperature of between 10° C. and 50° C. for a period of time of less than 48 hours.

According to one or more embodiments, the drying step c) is carried out at a temperature between 70° C. and 180° C.

Another subject according to the invention relates to a process for preparing an electrode comprising at least the following steps:
1) dissolving at least one ionic conductive polymer binder in a solvent or a solvent mixture;
2) adding at least one catalytic material according to the invention or a catalytic material obtained according to the preparation process according to the invention, in powder form, to the solution obtained in step 1) in order to obtain a mixture;
steps 1) and 2) being carried out in any order or simultaneously;
3) depositing the mixture obtained in step 2) on a metallic conductive support or collector.

Another subject according to the invention relates to an electrolysis device comprising an anode, a cathode and an electrolyte, said device being characterized in that at least one of the anode or of the cathode is an electrode obtained according to the preparation process according to the invention.

Another subject according to the invention relates to the use of the electrolysis device according to the invention in electrochemical reactions, wherein said device is used as:
a water electrolysis device for the production of a gaseous mixture of hydrogen and oxygen and/or the production of hydrogen alone;
a carbon dioxide electrolysis device for the production of formic acid;
a nitrogen electrolysis device for the production of ammonia;
a fuel cell device for the production of electricity from hydrogen and oxygen.

### DETAILED DESCRIPTION OF THE INVENTION

### Definitions

In the text hereinbelow, the groups of chemical elements are given according to the CAS classification (CRC Handbook of Chemistry and Physics, published by CRC Press, editor-in-chief D. R. Lide, 81^{st} edition, 2000-2001). For example, group IVB according to the CAS classification corresponds to the metals from column 4 (for example Ti, Zr and Hf) according to the new IUPAC classification, and group VIII (or VIIIB) according to the CAS classification corresponds to the metals from columns 8, 9 and 10 according to the new IUPAC classification. BET specific surface area is understood to mean the specific surface area determined by nitrogen adsorption in accordance with the standard ASTM D 3663-78 drawn up from the Brunauer-Emmett-Teller method described in the periodical The Journal of the American Chemical Society, 60, 309 (1938).

### Preparation Process

The process for preparing a catalytic material of an electrode for electrochemical reduction reactions, said material comprising an active phase based on at least one group VIB metal, at least one group IVB metal and an electrically conductive support, comprises at least the following steps:
a) a step of bringing said support into contact with at least one solution containing at least one precursor of at least one group VIB metal;
b) a step of bringing said support into contact with at least one solution containing at least one precursor of at least one group IVB metal;
steps a) and b) being carried out in any order or simultaneously;
c) a drying step on conclusion of the sequence of steps a) and b) or b) and a), at a temperature below 250° C., without a subsequent calcination step;
d) a step of sulfurization of the material obtained on conclusion of step c) at a temperature of between 100° C. and 600° C.

### Step a)

In accordance with step a) of the preparation process according to the invention, at least one step of bringing the support into contact with at least one solution containing at least one precursor of the active phase comprising at least one group VIB metal is carried out. Advantageously, the step of bringing the support into contact with at least one precursor of the active phase comprising at least one group VIB metal with the support, in accordance with the implementation of step a), can be carried out by dry impregnation or excess impregnation, or also by deposition-precipitation, according to methods well known to those skilled in the art. Preferably, said step a) is carried out by dry impregnation, which consists in bringing the support into contact with a solution containing at least one precursor comprising a group VIB, of which the volume of the solution is between 0.25 and 1.5 times the pore volume of the support to be impregnated.

### Precursors Comprising at Least One Group VIB Metal

The precursors comprising at least one group VIB metal can be chosen from all the precursors of the group VIB elements known to those skilled in the art. They can be chosen from polyoxometalates (POMs) or salts of precursors of the group VIB elements, such as molybdates, thiomolybdates, tungstates or else thiotungstates. They may be chosen from group VIB oxides. They may be chosen from organic or inorganic precursors, such as MoCl₅ or WCl₄ or WCl₆ or alkoxides of Mo or W, for example Mo(OEt)₅ or W(OEt)₅.

In the context of the present invention, polyoxometalates (POM) are understood to be the compounds corresponding to the formula (HₕXₓMₘO_{y})^{q-} wherein H is hydrogen, X is an element chosen from phosphorus (P), silicon (Si) and boron (B), said element being taken alone, M is one or more elements chosen from molybdenum (Mo) and/or tungsten (W), O being oxygen, h being an integer between 0 and 12, x being an integer between 0 and 4, m being an integer equal to 5, 6, 7, 8, 9, 10, 11, 12 or 18, y being an integer between 17 and 72 and q being an integer between 1 and 20.

The polyoxometalates defined according to the invention encompass two families of compounds: isopolyanions and heteropolyanions. These two families of compounds are defined in the paper Heteropoly and Isopoly Oxometallates, Pope, published by Springer-Verlag, 1983.

The isopolyanions which can be used in the present invention are polyoxometalates of general formula (HₕXₓMₘO_{y})^{q-} in which x=0, the other elements having the abovementioned meanings. Preferably, the m atoms M of said isopolyanions are either solely molybdenum atoms, or solely tungsten atoms, or a mixture of molybdenum and tungsten atoms.

Preferably, in the case where the element M is molybdenum (Mo), m is equal to 7 or 12. Likewise, preferably, in the case where the element M is tungsten (W), m is equal to 12.

The isopolyanions Mo₇O₂₄⁶⁻ and H₂W₁₂O₄₀⁶⁻ are advantageously used as active phase precursors in the context of the invention.

The heteropolyanions which can be used in the present invention are polyoxometalates of formula (HₕXₓMₘO_{y})^{q-} in which x=1, 2, 3 or 4, the other elements having the abovementioned meanings.

Heteropolyanions generally exhibit a structure in which the element X is the “central” atom and the element M is a metallic atom virtually systematically in octahedral coordination with X other than M.

Preferably, the m atoms M are either solely molybdenum atoms, or solely tungsten atoms, or a mixture of tungsten and molybdenum atoms.

Preferably, the element X is at least one phosphorus atom.

Heteropolyanions are negatively-charged polyoxometalate species. In order to compensate for these negative charges, it is necessary to introduce counterions and more particularly cations. These cations can advantageously be protons H⁺, or any other cation of NH₄⁺ type, or metal cations.

In the case where the counterions are protons, the molecular structure comprising the heteropolyanion and at least one proton constitutes a heteropolyacid. The heteropolyacids which can be used as active phase precursors in the present invention can, by way of example, be phosphomolybdic acid (3H⁺, PMo₁₂O₄₀³⁻) or else phosphotungstic acid (3H⁺, PW₁₂O₄₀³⁻). In the case where the counterions are not protons, reference is then made to heteropolyanion salt in order to designate this molecular structure. It is then possible to advantageously take advantage of the combination within the same molecular structure, via the use of a heteropolyanion salt, of the metal M and of its promoter, that is to say of the element titanium and/or of the element zirconium and/or of the element hafnium, which can either be in position X within the structure of the heteropolyanion, or in partial replacement of at least one atom M of molybdenum and/or of tungsten within the structure of the heteropolyanion, or in a counterion position.

Preferably, the polyoxometalates used according to the invention are the compounds corresponding to the formula (HₕXₓMₘO_{y})^{q-} in which H is hydrogen, X is an element chosen from phosphorus (P), silicon (Si) and boron (B), said element being taken alone, M is one or more element(s) chosen from molybdenum (Mo) and/or tungsten (W), O being oxygen, h being an integer between 0 and 6, x being an integer which can be equal to 0, 1 or 2, m being an integer equal to 5, 6, 7, 9, 10, 11 and 12, y being an integer between 17 and 48 and q being an integer between 3 and 12.

More preferably, the polyoxometalates used according to the invention are the compounds corresponding to the formula (HₕXₓMₘO_{y})^{q-}, in which h being an integer equal to 0, 1, 4 or 6, x being an integer equal to 0, 1 or 2, m being an integer equal to 5, 6, 10 or 12, y being an integer equal to 23, 24, 38 or 40 and q being an integer equal to 3, 4, 6 and 7, H, X, M and O having the abovementioned meanings.

The preferred polyoxometalates used according to the invention are advantageously chosen from polyoxometalates of formula PMo₁₂O₄₀³⁻, PW₁₂O₄₀³⁻, SiMo₁₂O₄₀⁴⁻, SiW₁₂O₄₀³⁻ or P₂Mo₅O₂₃⁶⁻, taken alone or as a mixture.

Other preferred polyoxometalates which can advantageously be used in the process according to the invention are the “Keggin” heteropolyanions of general formula XM₁₂O₄₀^{q-} for which the m/x ratio is equal to 12 and the “lacunary Keggin” heteropolyanions of general formula XM₁₁O₃₉^{q-} for which the m/x ratio is equal to 11 and in which the elements X and M and the charge q have the abovementioned meanings. X is thus an element chosen from phosphorus (P), silicon (Si) and boron (B), said element being taken alone, M is one or more elements chosen from molybdenum (Mo) and/or tungsten (W), and q is an integer between 1 and 20 and preferably between 3 and 12.

Said Keggin species are advantageously obtained for pH ranges which can vary according to the production routes described in the publication by A. Griboval, P. Blanchard, E. Payen, M. Fournier and J. L. Dubois, Chemistry Letters, 1997, vol. 26, no. 12, 1259-1260.

Salts of heteropolyanions of Keggin or lacunary Keggin type can also advantageously be used according to the invention.

Another preferred polyoxometalate which can advantageously be used as precursor employed in the process according to the invention is the Strandberg heteropolyanion of formula HₙP₂Mo₅O₂₃^{(6-h)-}, h being equal to 0, 1 or 2 and for which the m/x ratio is equal to 5/2.

The preparation of said Strandberg heteropolyanions and in particular of said heteropolyanion of formula HₙP₂Mo₅O₂₃^{(6-h)-} is described in the paper by W-C. Cheng and N. P. Luthra, J. Catal., 1988, 109, 163.

Said precursor comprising at least one group VIB metal is at least partially soluble in an aqueous phase or in an organic phase. The solvents used are generally water, an alcohol (preferably ethanol), an ether, a ketone, a chlorinated compound or an aromatic compound. Water, acidified water, toluene, benzene, dichloromethane, tetrahydrofuran, cyclohexane, n-hexane, ethanol, methanol and acetone are preferably used. When the group VIB metal is introduced in the form of an alkoxide or in the form of an organic precursor, the solvent is preferably chosen from toluene, benzene, dichloromethane, tetrahydrofuran, cyclohexane, and n-hexane.

Thus, by virtue of various preparation methods, many polyoxometalates and their associated salts are available. In general, all these polyoxometalates and their associated salts can advantageously be used during the electrolysis carried out in the process according to the invention. However, the preceding list is not exhaustive and other combinations can be envisaged.

### Step b)

In accordance with step b) of the preparation process according to the invention, at least one step of bringing the support into contact with at least one solution containing at least one precursor of the active phase comprising at least one group IVB metal is carried out. Advantageously, the step of bringing the support into contact with at least one precursor of the active phase comprising at least one group IVB metal with the support, in accordance with the implementation of step b), can be carried out by dry impregnation or excess impregnation, or else by deposition-precipitation, according to methods well known to those skilled in the art. Preferably, said step b) is carried out by dry impregnation, which consists in bringing the support into contact with a solution containing at least one precursor comprising a group IVB, of which the volume of the solution is between 0.25 and 1.5 times the pore volume of the support to be impregnated.

### Precursors Comprising at Least One Group IVB Metal

The precursors comprising at least one group IVB metal can be chosen from all the precursors of the group IVB elements known to those skilled in the art.

The preferred group IVB elements are non-noble elements: they are chosen from titanium (Ti), zirconium (Zr) and hafnium (Hf). The group IVB metal can be introduced in the form of salts, chelating compounds, alkoxides or glycoxides. The sources of group IVB elements which can advantageously be used in the form of salts are well known to those skilled in the art. They are chosen from nitrates, sulfates, hydroxides, phosphates, carbonates and halides chosen from chlorides, bromides and fluorides.

The group IVB elements can also be introduced in the form of oxides, in which case the precursor will be dissolved using an acid solution (nitric acid, phosphoric acid, hydrochloric acid, hydrofluoric acid, sulfuric acid, H₂O₂, etc.) before impregnating the support.

Said precursor comprising at least one group IVB metal is partially soluble in an aqueous phase or in an organic phase. The solvents used are generally water, an alkane, an alcohol, an ether, a ketone, a chlorinated compound or an aromatic compound. Aqueous acid solution, toluene, benzene, dichloromethane, tetrahydrofuran, cyclohexane, n-hexane, ethanol, methanol and acetone are preferably used. The group IVB metal is preferably introduced in the form of an alkoxide when an organic solvent is used.

Preferably, in an aqueous solution, the Zr precursor is zirconium hydroxide (Zr(OH)₄), the Hf precursor is hafnium hydroxide, hafnium oxalate, hafnium nitrate or hafnium sulfate.

In one embodiment, the precursors of zirconium, hafnium and titanium are chosen from alkoxides of zirconium, hafnium and titanium.

### Implementation of Steps a) and b)

According to one embodiment according to the invention, said precursor comprising at least one group IVB metal is introduced either:
i) before the contacting step a), in a “pre-impregnation” step using a solution comprising at least one precursor comprising at least one group IVB metal;
ii) during the contacting step a), in co-impregnation with said solution comprising at least one precursor comprising at least one group VIB metal;
iii) after the contacting step a), in a “post-impregnation” step using a solution containing at least one precursor comprising at least one group IVB metal.

Each step a) and b) of bringing the support into contact with at least one solution containing at least one precursor of the active phase comprising at least one group VIB metal (step a), and for bringing the support into contact with at least one solution containing at least one precursor of the active phase comprising at least one group IVB metal (step b) is carried out at least once and can advantageously be carried out several times, all possible combinations of implementations of steps a) and b) are included within the scope of the invention.

Each contacting step can preferably be followed by an intermediate drying step. The intermediate drying stage is carried out at a temperature below 250° C., preferably between 15° C. and 240° C., more preferentially between 30° C. and 220° C., even more preferentially between 50° C. and 200° C., and even more preferentially between 70° C. and 180° C.

Advantageously, after each contacting step, the impregnated support can be left to mature, optionally before an intermediate drying step. Maturation makes it possible for the solution to be distributed homogeneously within the support. When a maturation step is carried out, said step is advantageously carried out at atmospheric pressure, under an inert atmosphere or under an atmosphere containing oxygen or under an atmosphere containing water or the impregnation solvent, and at a temperature of between 10° C. and 50° C., and preferably at ambient temperature. Generally, a maturing time of less than 48 hours and preferably of between 5 minutes and 12 hours is sufficient.

Advantageously, when steps a) and b) are not carried out simultaneously, each contacting step can preferably be followed by an intermediate drying step, as described above, and then by an intermediate sulfurization step.

The intermediate sulfurization step can advantageously be carried out using an H₂S/H₂ or H₂S/N₂ gas mixture containing at least 5% by volume of H₂S in the mixture or under a stream of pure H₂S at a temperature of between 100° C. and 600° C., under a total pressure equal to or greater than 0.1 MPa for at least 2 hours. Preferably, the sulfurization temperature is between 350° C. and 550° C.

### Other Promoters

The solutions used in the various impregnation or successive impregnation steps can optionally contain at least one precursor of a doping element chosen from boron, phosphorus and silicon. The precursors of a doping element chosen from boron, phosphorus and silicon can also advantageously be added to impregnation solutions not containing the precursors of at least one metal chosen from the group formed by group IVB metals and group VIB metals, taken alone or as a mixture. Preferably, the doping element is phosphorus.

The solutions used in the various impregnation or successive impregnation steps can optionally contain at least one organic compound. Said organic compound can be chosen from all the organic compounds known to a person skilled in the art and is selected in particular from chelating agents, non-chelating agents, reducing agents or non-reducing agents. It can also be chosen from mono-, di- or polyalcohols which are optionally etherified, carboxylic acids, sugars, noncyclic mono-, di- or polysaccharides, such as glucose, fructose, maltose, lactose or sucrose, esters, ethers, crown ethers, cyclodextrins and compounds containing sulfur or nitrogen, such as nitriloacetic acid, ethylenediaminetetraacetic acid or diethylenetriamine, alone or as a mixture.

Said precursors of the group IVB metals and group VIB metals, the precursors of the doping elements and the organic compounds are advantageously introduced into the impregnation solution(s) in an amount such that the contents of group IVB element, of group VIB element, of doping element and of organic additives on the final catalyst are as defined below.

### Drying Step c)

The drying step is carried out at a temperature below 250° C., preferably between 15° C. and 240° C., more preferentially between 30° C. and 220° C., even more preferentially between 50° C. and 200° C., and even more preferentially between 70° C. and 180° C. Very preferably, the drying is carried out at reduced pressure at a temperature not exceeding 80° C. The drying time is between 30 minutes and 24 hours, preferably between 30 minutes and 16 hours. Preferably, the drying time does not exceed 4 hours.

The drying step can be carried out by any technique known to a person skilled in the art. It is advantageously carried out under an inert atmosphere or under an oxygen-containing atmosphere. It is advantageously carried out at atmospheric pressure or at reduced pressure.

### Sulfurization Step d)

The sulfurization carried out during step d) is intended to at least partially sulfurize the group VIB metal, and optionally at least partially sulfurize the group IVB metal.

The sulfurization step d) can advantageously be carried out using an H₂S/H₂ or H₂S/N₂ gas mixture containing at least 5% by volume of H₂S in the mixture or under a stream of pure H₂S at a temperature of between 100° C. and 600° C., under a total pressure equal to or greater than 0.1 MPa, for at least 2 hours.

Preferably, the sulfurization temperature is between 250° C. and 450° C.

### Catalytic Material

The activity of the catalytic material for the production of hydrogen by electrolysis of water is ensured by an active phase comprising, preferably consisting of, at least one group VIB element at least partly in sulfide form and at least one group IVB element at least partly in sulfide form. Advantageously, the active phase is chosen from the group formed by combinations of the elements titanium-molybdenum or zirconium-molybdenum or hafnium-molybdenum or titanium-zirconium-molybdenum or titanium-hafnium-molybdenum or zirconium-hafnium-molybdenum or titanium-tungsten or zirconium-tungsten or hafnium-tungsten or titanium-zirconium-tungsten or titanium-hafnium-tungsten or zirconium-hafnium-tungsten or titanium-molybdenum-tungsten or zirconium-molybdenum-tungsten or hafnium-molybdenum-tungsten.

When the group VIB metal is molybdenum, the content of molybdenum (Mo) is between 4% and 60% by weight of Mo element relative to the weight of the final catalytic material, and preferably between 7% and 50% by weight relative to the weight of the final catalytic material obtained after the last preparation step, i.e. the sulfurization.

When the group VIB metal is tungsten, the content of tungsten (W) is between 7% and 70% by weight of W element relative to the weight of the final catalytic material, and preferably between 12% and 60% by weight relative to the weight of the final catalytic material obtained after the last preparation step, i.e. the sulfurization.

The surface density which corresponds to the amount of molybdenum Mo atoms and/or tungsten W atoms, deposited per unit surface area of support, will advantageously be between 0.5 and 20 atoms of Mo and/or of W per square nanometer of support, and preferably between 2 and 15 Mo and/or W atoms per square nanometer of support.

The content of group IVB metal is advantageously between 0.1% and 25% by weight, preferably between 0.5% and 20% by weight of group IVB element relative to the total weight of the final catalytic material obtained after the last preparation step, i.e. the sulfurization.

### Support for the Catalytic Material

The support for the catalytic material is a support comprising, preferably consisting of, at least one electrically conductive material.

In one embodiment according to the invention, the support for the catalytic material comprises at least one material chosen from carbon structures, preferably carbon black, graphite, carbon nanotubes or graphene.

In one embodiment according to the invention, the support for the catalytic material comprises at least one material chosen from nickel, gold, copper, silver, titanium or silicon.

In one embodiment according to the invention, the support for the catalytic material comprises a material chosen from fluorine-doped tin oxide (FTO), indium tin oxide (ITO) and any other transparent conductive support.

A porous and nonelectrically-conductive material can be rendered electrically conductive by depositing an electrically conductive material at the surface thereof; mention may be made, for example, of a refractory oxide, such as an alumina, within which graphitic carbon is deposited. The support for the catalytic material advantageously exhibits a BET specific surface area (S_{BET}) of greater than 75 m²/g, preferably greater than 100 m²/g, very preferably greater than 130 m²/g.

### Electrode

The catalytic material capable of being obtained by the preparation process according to the invention can be used as electrode catalytic material capable of being used for electrochemical reactions, and in particular for the electrolysis of water in a liquid electrolytic medium.

Advantageously, the electrode comprises a catalytic material obtained by the preparation process according to the invention and a binder.

The binder is preferably a polymer binder chosen for its ability to be deposited in the form of a layer of variable thickness and for its capacities in terms of ionic conduction in an aqueous medium and diffusion of dissolved gases. The layer of variable thickness, advantageously of between 1 and 500 μm, in particular of the order of 10 to 100 μm, can in particular be a gel or a film.

Advantageously, the ionic conductive polymer binder is:
either conductive of anionic groups, in particular of hydroxy group, and is chosen from the group comprising in particular:
polymers stable in an aqueous medium, which can be perfluorinated, partially fluorinated or nonfluorinated and which have cationic groups enabling the conduction of hydroxide anions, said cationic groups being of quaternary ammonium, guanidinium, imidazolium, phosphonium, pyridium or sulfide type;
ungrafted polybenzimidazole;
chitosan; and
mixtures of polymers comprising at least one of the various polymers mentioned above, said mixture having anionic conductive properties;
or conductive of cationic groups enabling the conduction of protons and is chosen from the group comprising in particular:
polymers which are stable in an aqueous medium, which can be perfluorinated, partially fluorinated or nonfluorinated and which have anionic groups enabling the conduction of protons;
grafted polybenzimidazole;
chitosan; and
mixtures of polymers comprising at least one of the various polymers mentioned above, said mixture having cationic conductive properties.

Mention may in particular be made, among the polymers which are stable in an aqueous medium and which have cationic groups enabling the conduction of anions, of polymer chains of perfluorinated type, such as, for example, polytetrafluoroethylene (PTFE), of partially fluorinated type, such as, for example, polyvinylidene fluoride (PVDF), or of nonfluorinated type, such as polyethylene, which will be grafted with anionic conductive molecular groups.

Among the polymers which are stable in an aqueous medium and which have anionic groups enabling the conduction of protons, consideration may be given to any polymer chain stable in an aqueous medium containing groups such as —SO₃⁺, —COO⁺, —PO₃²⁻, —PO₃H⁻ or —C₆H₄O⁻. Mention may in particular be made of Nation®, sulfonated phosphonated polybenzimidazole (PBI), sulfonated or phosphonated polyetheretherketone (PEEK).

In accordance with the present invention, any mixture comprising at least two polymers, one at least of which is chosen from the groups of polymers mentioned above, can be used, provided that the final mixture is ionic conductive in an aqueous medium. Thus, mention may be made, by way of example, of a mixture comprising a polymer stable in an alkaline medium and having cationic groups enabling the conduction of hydroxide anions with a polyethylene not grafted by anionic conductive molecular groups, provided that this final mixture is anionic conductive in an alkaline medium. Mention may also be made, by way of example, of a mixture of a polymer stable in an acidic or alkaline medium and having anionic or cationic groups enabling the conduction of protons or hydroxides and of grafted or ungrafted polybenzimidazole.

Advantageously, polybenzimidazole (PBI) is used in the present invention as binder. It is not intrinsically a good ionic conductor but, in an alkaline or acidic medium, it proves to be an excellent polyelectrolyte with respectively very good anionic or cationic conduction properties. PBI is a polymer generally used, in the grafted form, in the manufacture of proton conductive membranes for fuel cells, in membrane-electrode assemblies and in PEM electrolyzers, as an alternative to Nafion®. In these applications, the PBI is generally functionalized/grafted, for example by a sulfonation, in order to render it proton conductive. The role of PBI in this type of system is then different from that which it has in the manufacture of the electrodes according to the present invention, where it is used only as binder and has no direct role in the electrochemical reaction.

Even if its long-term stability in a concentrated acid medium is limited, chitosan, which can also be used as an anionic or cationic conductive polymer, is a polysaccharide exhibiting ionic conduction properties in a basic medium which are similar to those of PBI (G. Couture, A. Alaaeddine, F. Boschet and B. Ameduri, Progress in Polymer Science, 36 (2011), 1521-1557). Advantageously, the electrode according to the invention is formulated by a process which additionally comprises a step of removal of the solvent at the same time as or after step 3). Removal of the solvent can be carried out by any technique known to those skilled in the art, notably by evaporation or phase inversion.

In the case of evaporation, the solvent is an organic or inorganic solvent, the evaporation temperature of which is below the decomposition temperature of the polymer binder used. Mention may be made, as examples, of dimethyl sulfoxide (DMSO) or acetic acid or propanol. A person skilled in the art is capable of choosing the organic or inorganic solvent suitable for the polymer or for the polymer mixture used as binder and capable of being evaporated.

According to a preferred embodiment of the invention, the electrode is able to be used for the electrolysis of water in an alkaline liquid electrolyte medium and the polymer binder is then an anionic conductor in an alkaline liquid electrolyte medium, in particular a conductor of hydroxides.

Within the meaning of the present invention, alkaline liquid electrolyte medium is understood to mean a medium with a pH of greater than 7, advantageously greater than 10.

The binder is advantageously conductive of hydroxides in an alkaline medium. It is chemically stable in electrolysis baths and has the capacity to diffuse and/or transport the OH ions involved in the electrochemical reaction to the surface of the particles, which are sites of redox reactions for the production of H₂ and O₂ gases. Thus, a surface which is not in direct contact with the electrolyte is all the same involved in the electrolysis reaction, a key point in the effectiveness of the system. The binder chosen and the shaping of the electrode do not hinder the diffusion of the gases formed and limit their adsorption, thus making possible their discharge. According to another preferred embodiment of the invention, the electrode is capable of being used for the electrolysis of water in an acidic liquid electrolyte medium and the polymer binder is a cationic conductor in an acidic liquid electrolyte medium, in particular conductive of protons.

Within the meaning of the present invention, acidic medium is understood to mean a medium with a pH of less than 7, advantageously less than 2.

Those skilled in the art, in the light of their general knowledge, will be capable of defining the amounts of each component of the electrode. The density of the particles of catalytic material must be sufficient to reach their electrical percolation threshold.

According to a preferred embodiment of the invention, the polymer binder/catalytic material weight ratio is between 5/95 and 95/5, preferably between 10/90 and 90/10 and more preferentially between 60/40 and 40/60.

### Electrode Preparation Process

The electrode can be prepared according to techniques well known to a person skilled in the art. More particularly, the electrode is prepared by a process comprising the following steps:
1) dissolving at least one ionic conductive polymer binder in a solvent or a solvent mixture;
2) adding at least one catalytic material prepared according to the invention, in powder form, to the solution obtained in step 1) in order to obtain a mixture;
steps 1) and 2) being carried out in any order or simultaneously;
3) depositing the mixture obtained in step 2) on a metallic or metallic-type conductive support or collector.

Within the meaning of the invention, catalytic material powder is understood to mean a powder consisting of particles of micron, submicron or nanometer size. The powders can be prepared by techniques known to a person skilled in the art.

Within the meaning of the invention, metallic-type support or collector is understood to mean any conductive material having the same conduction properties as metals, for example graphite or certain conductive polymers, such as polyaniline and polythiophene. The mixture obtained (between the binder and the catalytic material) can be deposited on the support by any method chosen from the group comprising in particular dip coating, printing, induction, pressing, coating, spin coating, filtration, vacuum deposition, spray deposition, casting, extrusion or laminating. Said support or said collector can be solid or perforated. Mention may be made, as an example of a support, of a grid (perforated support) or a plate or a sheet of stainless steel (304L or 316L, for example) (solid supports).

The advantage of the mixture according to the invention is that it can be deposited on a solid or perforated collector, by the usual easily accessible deposition techniques which enable deposition in the forms of layers of variable thicknesses, ideally of the order of from 10 to 100 μm.

In accordance with the invention, the mixture can be prepared by any technique known to a person skilled in the art, in particular by mixing the binder and at least one catalytic material in powder form in a solvent or a mixture of solvents suitable for obtaining a mixture with the rheological properties enabling the deposition of the electrode materials in the form of a film of controlled thickness on an electron conductive substrate. The use of the catalytic material in powder form enables maximization of the surface area developed by the electrodes and enhancement of the associated performance qualities. Those skilled in the art will be able to make the choices of the various formulation parameters in the light of their general knowledge and of the physicochemical characteristics of said mixtures.

### Operating Processes

Another subject according to the invention relates to an electrolysis device comprising an anode, a cathode and an electrolyte, in which at least one of the anode or of the cathode is an electrode according to the invention.

The electrolysis device can be used as a water electrolysis device for the production of a gaseous mixture of hydrogen and oxygen and/or the production of hydrogen alone comprising an anode, a cathode and an electrolyte, said device being characterized in that one at least of the cathode or of the anode is an electrode according to the invention, preferably the cathode. The electrolysis device consists of two electrodes (an anode and a cathode, which are electron conductors) connected to a direct current generator and separated by an electrolyte (ionic conductive medium). The anode is the site of the oxidation of the water. The cathode is the site of the reduction of the protons and the formation of hydrogen.

The electrolyte can be:
either an acidic (H₂SO₄ or HCl, and the like) or basic (KOH) aqueous solution;
or a proton exchange polymer membrane which ensures the transfer of the protons from the anode to the cathode and enables the separation of the anode and cathode compartments, which prevents the species reduced at the cathode from reoxidizing at the anode, and vice versa;
or a ceramic membrane conductive of O₂⁻ ions. Reference is then made to a solid oxide electrolysis (SOEC or Solid Oxide Electrolyzer Cell).

The minimum water supply of an electrolysis device is 0.8 l/Sm³ of hydrogen. In practice, the actual value is close to 1 l/Sm³. The water introduced must be as pure as possible because the impurities remain in the equipment and accumulate over the course of the electrolysis, ultimately disrupting the electrolytic reactions by:
the formation of sludges; and by
the action of chlorides on the electrodes.

An important specification with regard to the water relates to its ionic conductivity (which must be less than a few μS/cm).

There are many suppliers offering very diversified technologies, in particular in terms of the nature of the electrolyte and of associated technology, ranging from a possible upstream coupling with a renewable electricity supply (photovoltaic or wind power) to the direct final provision of pressurized hydrogen.

The reaction has a standard potential of −1.23 V, which means that it ideally requires a potential difference between the anode and the cathode of 1.23 V. A standard cell usually operates under a potential difference of 1.5 V and at room temperature. Some systems can operate at higher temperature. This is because it has been shown that high temperature electrolysis (HTE) is more efficient than the electrolysis of water at room temperature, on the one hand because a portion of the energy required for the reaction can be contributed by the heat (cheaper than electricity) and, on the other hand, because the activation of the reaction is more efficient at high temperature. HTE systems generally operate between 100° C. and 850° C.

The electrolysis device can be used as a nitrogen electrolysis device for the production of ammonia, comprising an anode, a cathode and an electrolyte, said device being characterized in that one at least of the cathode or of the anode is an electrode according to the invention, preferably the cathode.

The electrolysis device consists of two electrodes (an anode and a cathode, which are electron conductors) connected to a direct current generator and separated by an electrolyte (ionic conductive medium). The anode is the site of the oxidation of the water. The cathode is the site of the nitrogen reduction and the ammonia formation. Nitrogen is continuously injected into the cathode compartment.

The nitrogen reduction reaction is:

N₂+6H⁺+6e⁻→2NH₃

The electrolyte can be:
either an aqueous solution (Na₂SO₄ or HCl), preferably saturated with nitrogen;
or a proton exchange polymer membrane which ensures the transfer of the protons from the anode to the cathode and enables the separation of the anode and cathode compartments, which prevents the species reduced at the cathode from reoxidizing at the anode, and vice versa.

The electrolysis device can be used as a carbon dioxide electrolysis device for the production of formic acid, comprising an anode, a cathode and an electrolyte, said device being characterized in that one at least of the cathode or of the anode is an electrode according to the invention. An example of anode and of electrolyte which can be used in such a device is described in detail in the document FR 3 007 427.

The electrolysis device can be used as a fuel cell device for the production of electricity from hydrogen and oxygen comprising an anode, a cathode and an electrolyte (liquid or solid), said device being characterized in that one at least of the cathode or of the anode is an electrode according to the invention.

The fuel cell device consists of two electrodes (an anode and a cathode, which are electron conductors) which are connected to a charge C for delivering the electric current produced and which are separated by an electrolyte (ionic conductive medium). The anode is the site of the oxidation of the hydrogen. The cathode is the site of the reduction of the oxygen.

The electrolyte can be:
either an acidic (H₂SO₄ or HCl, and the like) or basic (KOH) aqueous solution;
or a proton exchange polymer membrane which ensures the transfer of the protons from the anode to the cathode and enables the separation of the anode and cathode compartments, which prevents the species reduced at the cathode from reoxidizing at the anode, and vice versa;
or a ceramic membrane conductive of O₂⁻ ions. Reference is then made to a solid oxide fuel cell (SOFC).

The following examples illustrate the present invention without, however, limiting the scope thereof. The examples below relate to the electrolysis of water in a liquid electrolyte medium for the production of hydrogen.

### EXAMPLES

### Example 1: Preparation of a Catalytic Material C1 (in Accordance with the Invention) from H₃PMo₁₂O₄₀, Zr(OH)₄ and H₃PO₄

The catalytic material C₁ (in accordance with the invention) is prepared by dry impregnation of 10 g of commercial carbon-type support (Ketjenblack®, 1400 m²/g) with 26 ml of solution. The solution is obtained by dissolving, in water, H₃PMo₁₂O₄₀ at a concentration of 2.6 mol/l, Zr(OH)₄, such that the Zr/Mo ratio=0.2, and H₃PO₄, such that the P/Mo ratio=0.65. The preparation of the catalyst is continued by a maturation step where the impregnated solid is kept in a closed chamber, the atmosphere of which is saturated with water, for 12 hours before undergoing a drying step at 60° C. (oil bath) under an inert atmosphere and at reduced pressure (while drawing under vacuum). The precatalyst is sulfurized under pure H₂S at a temperature of 350° C. for 2 hours under 0.1 MPa of pressure.

On the final catalyst, the amount of Mo corresponds to a surface density of 7 atoms per nm² and the Zr and P ratios are respectively: Ni/Mo=0.2 and P/Mo=0.65.

### Example 2: Preparation of a Catalytic Material C2 (not in Accordance with the Invention) from H₃PMo₁₂O₄₀, Ni(OH)₂ and Citric Acid

The catalytic material C₂ (not in accordance) is prepared by dry impregnation of 10 g of commercial carbon-type support (Ketjenblack®, 1400 m²/g) with 26 ml of solution. The solution is obtained by dissolving, in water, H₃PMo₁₂O₄₀ at a concentration of 2.6 mol/l, Ni(OH)₂, such that the Ni/Mo ratio=0.2, and citric acid, such that the “citric acid/Mo” ratio=0.5. The preparation of the material is continued by a maturation step where the impregnated solid is kept in a closed chamber, the atmosphere of which is saturated with water, for 12 hours before undergoing a drying step at 60° C. (oil bath) under an inert atmosphere and at reduced pressure (while drawing under vacuum). The catalytic material precursor is sulfurized under pure H₂S at a temperature of 350° C. for 2 hours under 0.1 MPa of pressure.

On the final catalyst, the amount of Mo corresponds to a surface density of 7 atoms per nm² and the Ni and P ratios are respectively: Ni/Mo=0.2 and P/Mo=0.08.

### Example 3: Description of the Commercial Pt Catalyst (Catalyst C3)

The material C3 originates from Alfa Aesar®: it comprises platinum particles with an S_{BET}=27 m²/g.

### Example 4: Catalytic Test

The characterization of the catalytic activity of the catalytic materials is carried out in a 3-electrode cell. This cell is composed of a working electrode, of a platinum counterelectrode and of an Ag/AgCl reference electrode. The electrolyte is a 0.5 mol/l aqueous sulfuric acid (H₂SO₄) solution. This medium is deoxygenated by sparging with nitrogen and the measurements are taken under an inert atmosphere (deaeration with nitrogen).

The working electrode consists of a disk of glassy carbon with a diameter of 5 mm set in a Teflon tip (rotating disk electrode). Glassy carbon has the advantage of having no catalytic activity and of being a very good electrical conductor. In order to deposit the catalysts (C1, C2, C3) on the electrode, a catalytic ink is formulated. This ink consists of a binder in the form of a solution of 10 μl of 15 wt % Nafion®, of a solvent (1 ml of 2-propanol) and of 5 mg of catalyst (C1, C2, C3). The role of the binder is to ensure the cohesion of the particles of the supported catalyst and the adhesion to the glassy carbon. This ink is subsequently placed in an ultrasonic bath for 30 to 60 minutes in order to homogenize the mixture. 12 μl of the prepared ink is deposited on the working electrode (described above). The ink is subsequently deposited on the working electrode and then dried in order to evaporate the solvent.

Various electrochemical methods are used in order to determine the performance of the catalysts:
linear voltammetry: it consists in applying, to the working electrode, a potential signal which varies with time, i.e. from 0 to −0.5 V vs RHE at a rate of 2 mV/s, and in measuring the faradaic response current, that is to say the current due to the redox reaction taking place at the working electrode. This method is ideal for determining the catalytic power of a material for a given reaction. It makes it possible, inter alia, to determine the overpotential necessary for the reduction of the protons to give H₂.
   chronopotentiometry: it consists, for its part, in applying a current or a current density for a predetermined time and in measuring the resulting potential. This study makes it possible to determine the catalytic activity at constant current but also the stability of the system over time. It is carried out with a current density of −10 mA/cm² and for a given time.

The catalytic performance qualities are collated in table 1 below. They are expressed as overpotential at a current density of −10 mA/cm².

TABLE 1

| | Overpotential at −10 mA/cm² [(mV) |
|---|---|
| Catalytic materials | vs RHE] |
| C1 (in accordance) | −160 |
| C2 (not in accordance) | −190 |
| C3 (platinum, not in accordance) | −90 |

With an overpotential of only −160 mV vs RHE, the catalytic material C1, based on Zr and P, has particularly improved performance compared to the optimized electrocatalyst C2 based on MoS₂ (Ni, Mo, P formulation) and relatively close to that of platinum. This result demonstrates the indisputable advantage of the material C1 in accordance with the invention for the development of the hydrogen sector by electrolysis of water.

1. A catalytic material comprising an active phase comprising at least one group VIB metal at least partly in sulfide form, at least one group IVB metal at least partly in sulfide form, and an electrically conductive support wherein said group VIB metal is chosen from molybdenum and/or tungsten, said group IVB metal is chosen from titanium, zirconium and/or hafnium.

2. The catalytic material as claimed in claim 1, characterized in that when the group VIB metal is molybdenum, the molybdenum content is between 4% and 60% by weight of molybdenum element relative to the weight of the catalytic material.

3. The catalytic material as claimed in claim 1, characterized in that when the group VIB metal is tungsten, the tungsten content is between 7% and 70% by weight of tungsten element relative to the weight of the catalytic material.

4. The catalytic material as claimed in claim 1, characterized in that the content of group IVB metal is between 0.1% and 25% by weight of group IVB element relative to the total weight of the catalytic material.

5. The catalytic material as claimed in claim 1, characterized in that the active phase is chosen from the group formed by the combinations of the elements titanium-molybdenum, zirconium-molybdenum, hafnium-molybdenum, titanium-zirconium-molybdenum, titanium-hafnium-molybdenum, zirconium-hafnium-molybdenum, titanium-tungsten, zirconium-tungsten, hafnium-tungsten, titanium-zirconium-tungsten, titanium-hafnium-tungsten, zirconium-hafnium-tungsten, titanium-molybdenum-tungsten, zirconium-molybdenum-tungsten and hafnium-molybdenum-tungsten.

6. The catalytic material as claimed in claim 1, further comprising a dopant material chosen from boron, phosphorus and silicon.

7. The catalytic material as claimed in claim 1, wherein the electrically conductive support is chosen from:
carbon black, graphite, carbon nanotubes and graphene;
nickel, gold, copper, silver, titanium and silicon;
fluorine-doped tin dioxide and indium tin oxide.

8. The catalytic material as claimed in claim 1, characterized in that the support of the catalytic material has a specific surface area of greater than 75 m²/g.

9. A process for preparing a catalytic material as claimed in claim 1, said process comprises at least the following steps:
a) a step of bringing said support into contact with at least one solution containing at least one precursor of at least one group VIB metal;
b) a step of bringing said support into contact with at least one solution containing at least one precursor of at least one group IVB metal;
steps a) and b) being carried out in any order or simultaneously;
c) a drying step on conclusion of the sequence of steps a) and b) or b) and a), at a temperature below 250° C., without a subsequent calcination step;
d) a step of sulfurization of the material obtained on conclusion of step c) at a temperature of between 100° C. and 600° C.

10. The process as claimed in claim 9, wherein said precursor of at least one group VIB metal is chosen from:
polyoxometalates corresponding to the formula (HhXxMmOy)q- wherein H is hydrogen, X is an element chosen from phosphorus (P), silicon (Si) and boron (B), said element being taken alone, M is one or more elements chosen from molybdenum (Mo) and tungsten (W), O being oxygen, h being an integer between 0 and 12, x being an integer between 0 and 4, m being an integer equal to 5, 6, 7, 8, 9, 10, 11, 12 or 18, y being an integer between 17 and 72 and q being an integer between 1 and 20;
salts of precursors of the group VIB elements; and
organic or inorganic precursors based on Mo or W.

11. The process as claimed in claim 9, wherein said precursor of at least one group IVB metal is chosen from alkoxides of zirconium, hafnium and titanium, zirconium hydroxide, hafnium hydroxide, hafnium oxalate, hafnium nitrate and hafnium sulfate.

12. The process as claimed in claim 9, wherein a maturation step is carried out after step a) and/or b), and before step c), at a temperature of between 10° C. and 50° C. for a period of time of less than 48 hours.

13. A process for preparing an electrode, comprising at least the following steps:
1) dissolving at least one ionic conductive polymer binder in a solvent or a solvent mixture;
2) adding at least one catalytic material as claimed in claim 1, in powder form, to the solution obtained in step 1) in order to obtain a mixture;
steps 1) and 2) being carried out in any order or simultaneously;
3) depositing the mixture obtained in step 2) on a metallic conductive support or collector.

14. An electrolysis device comprising an anode, a cathode and an electrolyte, said device being characterized in that at least one of the anode or of the cathode is an electrode obtained according to the preparation process as claimed in claim 13.

15. The electrolysis device as claimed in claim 14, which is
a water electrolysis device for the production of a gaseous mixture of hydrogen and oxygen and/or the production of hydrogen alone;
a carbon dioxide electrolysis device for the production of formic acid;
a nitrogen electrolysis device for the production of ammonia;
a fuel cell device for the production of electricity from hydrogen and oxygen.

16. An electrolysis device, comprising the catalytic material as claimed in claim 1.

17. The electrolysis device according to claim 16, which is
a water electrolysis device for the production of a gaseous mixture of hydrogen and oxygen and/or the production of hydrogen alone;
a carbon dioxide electrolysis device for the production of formic acid;
a nitrogen electrolysis device for the production of ammonia;
a fuel cell device for the production of electricity from hydrogen and oxygen.
